(19) United States
(12) Patent Application Publication
(10) Pub. No.: US 2022/0203691 A1
(43) Pub. Date: Jun. 30, 2022

(54) LIQUID EJECTION APPARATUS

(71) Applicant: Brother Kogyo Kabushiki Kaisha, Nagoya (JP)

(72) Inventor: Yasuo NISHIKAWA, Nagoya (JP)

(73) Assignee: Brother Kogyo Kabushiki Kaisha, Nagoya (JP)

(21) Appl. No.: 17/645,346

(22) Filed: Dec. 21, 2021

(30) Foreign Application Priority Data
Dec. 25, 2020 (JP) 2020-216415

(51) Int. Cl. B41J 2/17; B41J 2/165; B41J 2/14

(52) U.S. Cl. CPC B41J 2/1721; B41J 2002/1742; B41J 2/14233; B41J 2/16523

(57) ABSTRACT

A liquid ejection apparatus includes a liquid ejection head having a nozzle surface with a plurality of nozzles, a conductive member configured to face the nozzle surface, a cap having a recess in which the conductive member is accommodated, a substrate including a signal output circuit, a controller configured to determine an ejection state of a nozzle based on a signal output from the signal output circuit, a waste liquid tank having an inlet, and a discharge mechanism configured to discharge liquid from the cap through the inlet into the waste liquid ink. The substrate is disposed above the inlet of the waste liquid tank.

### CROSS-REFERENCE TO RELATED APPLICATION

This application claims priority from Japanese Patent Application No. 2020-216415 filed on Dec. 25, 2020, the content of which is incorporated herein by reference in its entirety.

### TECHNICAL FIELD

Aspects of the disclosure relate to a liquid ejection apparatus having a conductive member configured to face a nozzle surface of a liquid ejection head.

### BACKGROUND

A known liquid ejection apparatus includes a print head having a plurality of nozzles, an ink absorbing member, and a mesh-like stainless regulating member disposed on the surface of the ink absorbing member. The regulating member is a conductive member and functions as an electrode. Ink is ejected from the nozzles toward the regulating member and the ink absorbing member having a wet surface, to determine an ejection state of each nozzle.

### SUMMARY

According to an aspect of the disclosure, a liquid ejection apparatus includes a liquid ejection head, a conductive member, a cap, a substrate, a controller, a waste liquid tank, and a discharge mechanism. The liquid ejection head has a nozzle surface with a plurality of nozzles. The liquid ejection head is configured to eject liquid from the nozzles. The conductive member is configured to face the nozzle surface. The cap has a recess in which the conductive member is accommodated. The cap is configured to receive liquid ejected from the nozzles. The substrate includes a signal output circuit configured to output a signal in response to ejection of liquid from a nozzle of the nozzles to the conductive member. The signal indicates a potential difference between the liquid ejection head and the conductive member. The controller is configured to determine an ejection state of the nozzle based on the signal output from the signal output circuit. The waste liquid tank has an inlet. The discharge mechanism is configured to discharge liquid from the cap through the inlet into the waste liquid ink. The substrate is disposed above the inlet of the waste liquid tank.

According to the liquid discharging apparatus of the disclosure, the liquid dripping from the inlet of the waste liquid tank hardly adheres to the substrate. This can also prevent short circuiting in the circuit (the signal output circuit) of the substrate.

### BRIEF DESCRIPTION OF THE DRAWINGS

FIG. 1 is a schematic plan view of a printer.

FIG. 2 is a cross-sectional view of a head included in the printer illustrated in FIG. 1.

FIG. 3 is a schematic plan view of a maintenance unit included in the printer illustrated in FIG. 1.

FIG. 4 is a cross-sectional view taken along a IV-IV line of FIG. 3.

FIG. 5 is a cross-sectional view taken along a V-V line of FIG. 3.

FIG. 6 is a perspective view of an accommodating member accommodated in a first cap portion illustrated in FIG. 3 when viewed obliquely from below.

FIG. 7A illustrates a stopper member in a first position in a recess of the first cap portion.

FIG. 7B illustrates the stopper member in a second position in the recess of the first cap portion.

FIG. 8 is a schematic plan view of a cap device illustrated in FIG. 3 when viewed from a bottom of a support member.

FIG. 9 is a block diagram illustrating an electrical configuration of the printer illustrated in FIG. 1.

FIG. 10A is a graph showing changes in potential of the accommodating member when an ink droplet has been ejected from a nozzle.

FIG. 10B is a graph showing no change in potential of the accommodating member when an ink droplet is not ejected from a nozzle.

### DETAILED DESCRIPTION

The above known liquid ejection apparatus further includes a voltage application circuit that generates a potential difference between the ink absorbing member and the print head, and a voltage detection circuit that detects a voltage change in the print head, a controller that controls the voltage application circuit and the voltage detection circuit, and a substrate provided with the controller. The substrate is attached to a back surface of a mechanical frame. If the voltage application circuit and the voltage detection circuit are disposed on the substrate, these circuits would be also disposed on the back surface, that is, the lower surface, of the mechanical frame. Ink ejected to a cap is usually discharged to a waste liquid tank using a pump. This waste liquid tank would be disposed on an upper surface of the mechanical frame. In the known liquid ejection apparatus, the substrate would be disposed below the waste liquid tank. Ink, which drips downward from an inlet through which ink flows into the waste liquid tank, would adhere to the substrate along the mechanical frame, causing a problem such as short-circuiting of the circuits of the substrate.

To solve the above problem, it is an object of the disclosure to provide a liquid ejection apparatus configured to prevent short-circuiting of a circuit on a substrate.

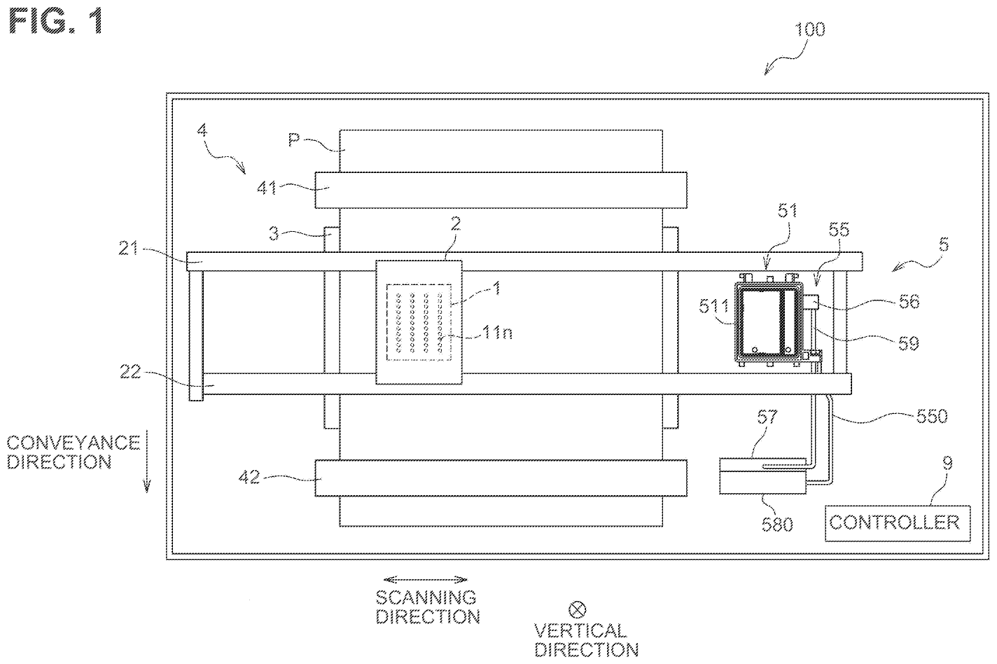

As illustrated in FIG. 1, a printer 100 according to an embodiment, as an example of a liquid ejection apparatus, includes a head 1, a carriage 2, a platen 3, a conveyance mechanism 4, a maintenance unit 5 including a cap device 51, and a controller 9.

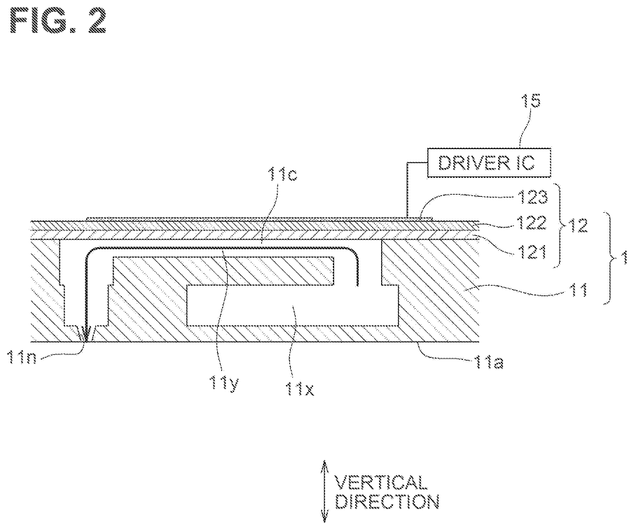

The head 1 is supplied with inks of four colors, black, yellow, cyan, and magenta, stored in four ink tanks. As illustrated in FIG. 2, the head 1 has a channel unit 11 and an actuator unit 12. The channel unit 11 has a lower surface which is a nozzle surface 11a having an array of nozzles 11n and is a horizontal surface orthogonal to the vertical direction. As illustrated in FIG. 1, the nozzles 11n are arranged into nozzle rows extending in a conveyance direction. The head 1 has four nozzle rows next to each other in the scanning direction parallel to the nozzle surface 11a. The conveyance direction is parallel to the nozzle surface 11a and orthogonal to the scanning direction. In the head 1, black ink is ejected from the nozzles 11n constituting the rightmost nozzle row in the scanning direction. Yellow ink is ejected from the nozzles 11n constituting the nozzle row to the left of the black nozzle row. Cyan ink is ejected from the nozzles 11n constituting the nozzle row to the left of the yellow nozzle row. Magenta ink is ejected from the nozzles 11n constituting the nozzle row to the left of the cyan nozzle row.

As illustrated in FIG. 2, the channel unit 11 has inside a common channel 11x communicating with an ink tank and a plurality of individual channels 11y each extending from the common channel 11x to a corresponding one of the nozzles 11n in a nozzle row. The channel unit 11 has an upper surface with a plurality of pressure chambers 11c which are open and each included in a corresponding one of the individual channels 11y. The actuator unit 12 includes: a vibrating plate 121 disposed on the upper surface of the channel unit 11 so as to cover the pressure chambers 11c; a piezoelectric layer 122 disposed on an upper surface of the vibrating plate 121; and a plurality of individual electrodes 123 disposed on the upper surface of the piezoelectric layer 122 such that each individual electrode 123 faces a corresponding one of the pressure chambers 11c. Portions of the vibrating plate 121 and the piezoelectric layer 122 sandwiched between the individual electrodes 123 and the pressure chambers 11c function as individual unimorph actuators for the pressure chambers 11c, and are independently deformable in accordance with the application of voltage to the individual electrodes 123 by a driver IC 15. When the actuator is deformed so as to be convex toward the pressure chamber 11c, the volume of the pressure chamber 11c is reduced, and ink in the pressure chamber 11c is pressurized and ejected from the nozzles 11n.

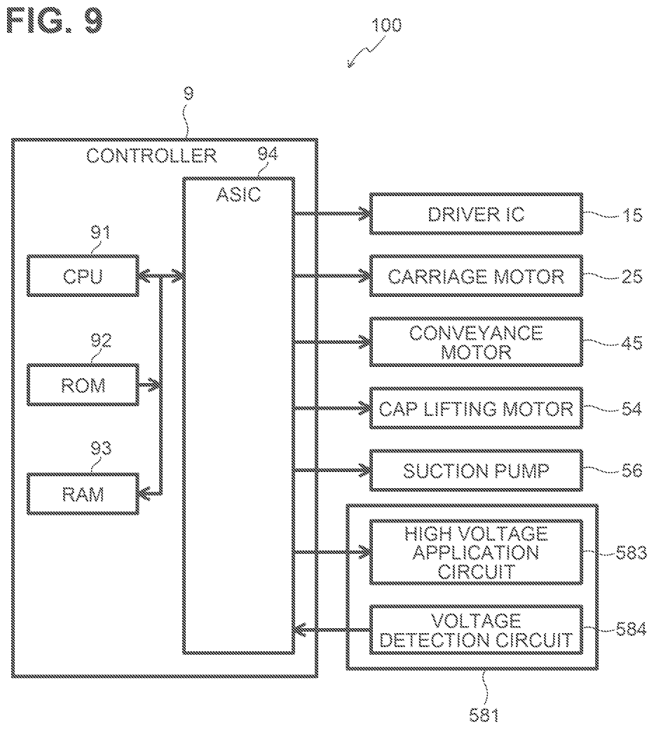

As illustrated in FIG. 1, the carriage 2 holds the head 1 and is supported by two guide rails 21 and 22 extending in the scanning direction. When a carriage motor 25 (see FIG. 9) is driven under the control of the controller 9, the carriage 2 is moved in the scanning direction along the guide rails 21 and 22 by a carriage moving mechanism (not shown). This allows the head 1 to take a maintenance position where the head 1 faces a cap 511 (described later) of the cap device 51 in the vertical direction and a non-maintenance position where the head 1 does not face the cap 511 of the cap device 51 in the vertical direction.

The platen 3 is disposed below the head 1 and the carriage 2. The platen 3 supports a sheet P on its upper surface.

The conveyance mechanism 4 includes two roller pairs 41 and 42 disposed with the platen 3 interposed therebetween in the conveyance direction. When a conveyance motor 45 (see FIG. 9) is driven under the control of the controller 9, the roller pairs 41 and 42 rotate while nipping the sheet P, and the sheet P is conveyed in the conveyance direction.

The maintenance unit 5 includes the cap device 51, a discharge mechanism 55, and a waste liquid tank 57. The maintenance unit 5 is disposed to one side of the platen 3 in the scanning direction.

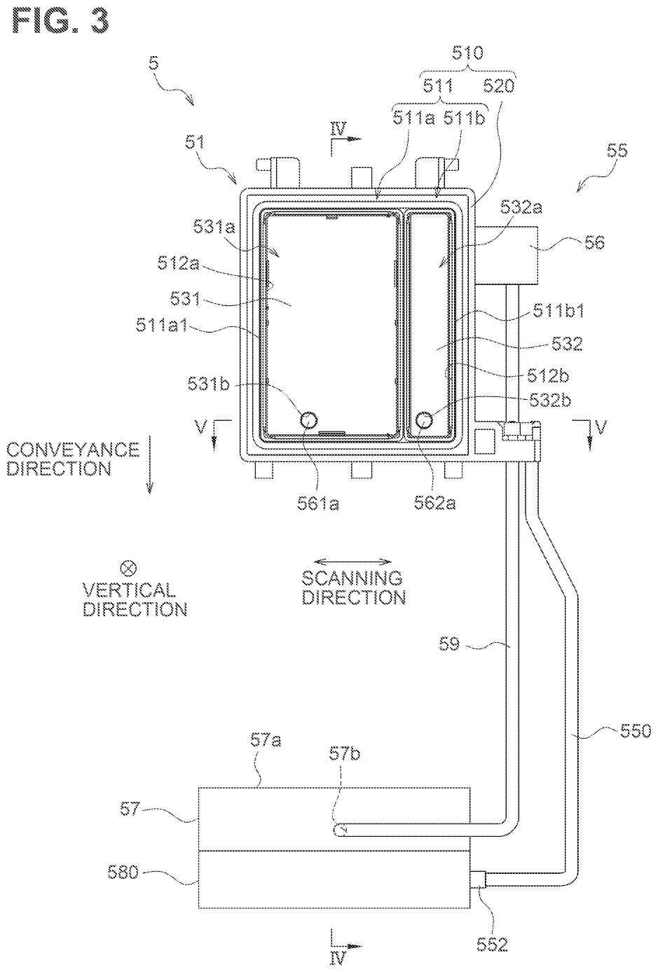

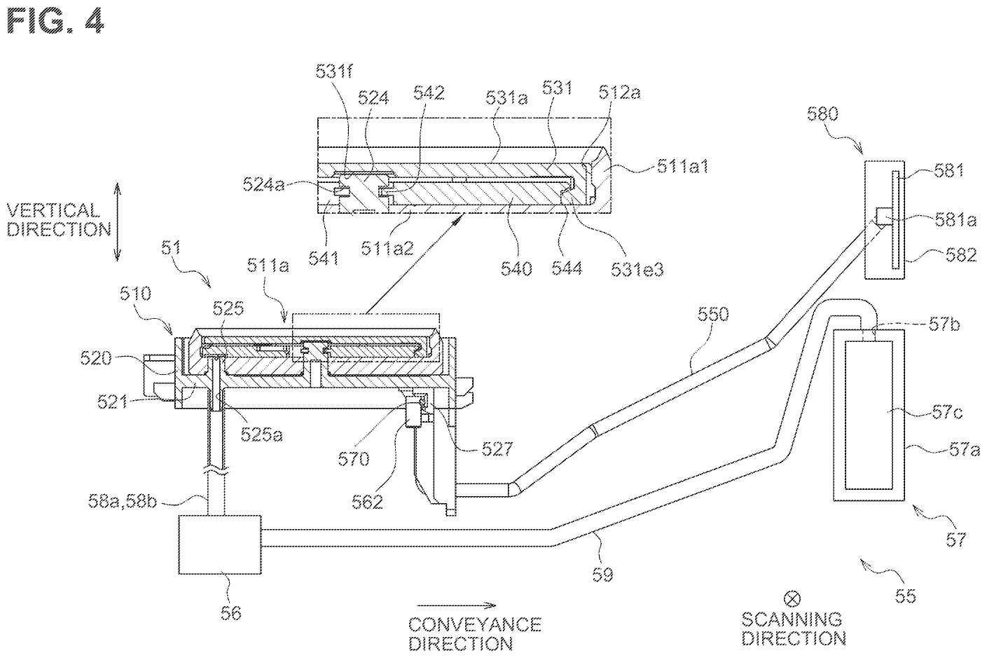

As illustrated in FIGS. 3 and 4, the cap device 51 includes two accommodating members 531 and 532, a support member 510 that supports the accommodating members 531 and 532, a high-voltage harness 550, and a substrate unit 580.

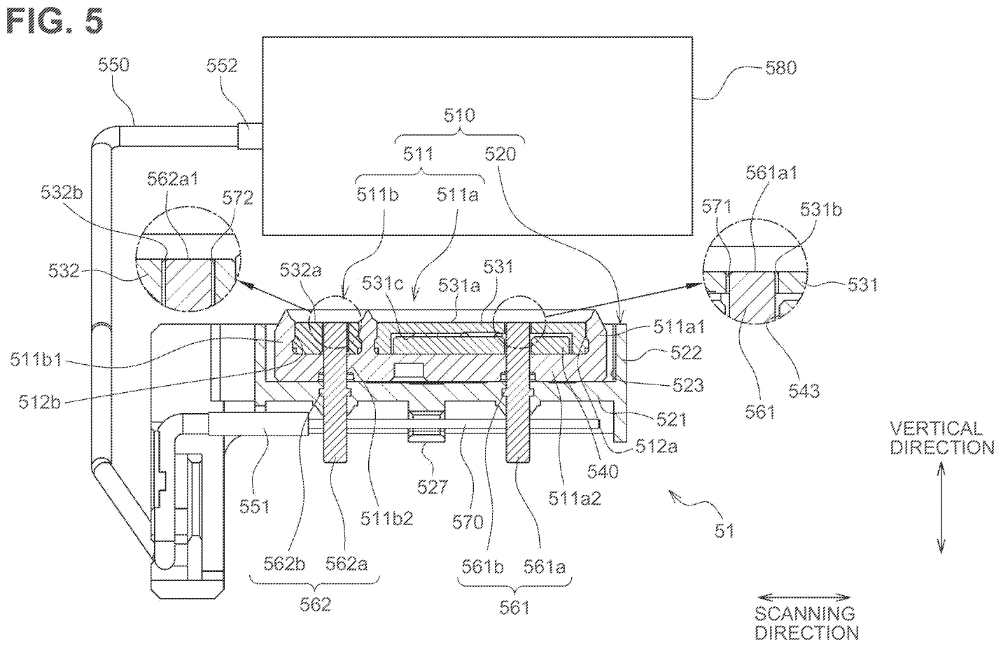

The support member 510 includes a cap 511, a holder 520 that supports the cap 511 from below, two electrode pins 561 and 562, and a stopper member 540. The cap 511 is non-conductive. In the embodiment, the cap 511 is made of an elastic material such as rubber. As illustrated in FIGS. 3 and 5, the cap 511 includes a first cap portion 511a and a second cap portion 511b. When the upper end portion of the cap 511 and the nozzle surface 11a are brought into intimate contact with each other, the first cap portion 511a covers all the nozzle 11n for ejecting color inks of yellow, cyan, and magenta. When the upper end portion of the cap 511 and the nozzle surface 11a are brought into intimate contact with each other, the second cap portion 511b covers all the nozzle 11n for ejecting black ink.

As illustrated in FIG. 3, the first cap portion 511a has a recess 512a that is open upward. The recess 512a is defined by an annular side wall 511a1 and a bottom portion 511a2 of the first cap portion 511a. The second cap portion 511b also has a recess 512b that is open upward. The recess 512b is defined by an annular side wall 511b1 and a bottom portion 511b2 of the second cap portion 511b. One side wall of the annular side wall 511a1 in the scanning direction (or its right side wall in FIG. 3) and the other side wall of the annular side wall 511b1 in the scanning direction (or its left side wall in FIG. 3) are common to each other.

As illustrated in FIG. 3, each of the two accommodating members 531 and 532 is a plate-shaped member having substantially a rectangular plane, is made of a synthetic resin having conductivity, for example, POM (polyacetal) containing carbon powder, and has electrical conductivity. The accommodating member 531 has a planar size larger than that of the accommodating member 532. Further, as illustrated in FIG. 5, the accommodating member 531 is disposed in the recess 512a of the first cap portion 511a, and its outer peripheral side surface abuts on the inner peripheral side surface of the annular side wall 511a1 defining the recess 512a. The accommodating member 531 is configured to face and be spaced from the nozzle surface 11a when the head 1 is at the maintenance position and the upper end portion of the cap 511 and the nozzle surface 11a are in intimate contact with each other. Specifically, the accommodating member 531 is configured to face all of the nozzles 11n for ejecting color inks other than black. That is, the upper surface of the accommodating member 531 forms a landing surface 531a on which the color ink droplets ejected from the nozzles 11n land.

As illustrated in FIGS. 4 and 5, the landing surface 531a is a horizontal surface, is parallel to the nozzle surface 11a of the head 1 in the maintenance position, and is flat. As illustrated in FIGS. 3 and 5, the accommodating member 531 has a circular hole 531b. The hole 531b is located in a downstream portion of the accommodating member 531 in the conveyance direction and to the left with respect to the center in the scanning direction in FIG. 3. The hole 531b receives an electrode pin 561. The electrode pin 561 has an upper end surface 561a1. The upper end surface 561a1 is exposed from the hole 531b so as to be flush with the upper surface of the accommodating member 531, and forms the landing surface 531a together with the upper surface of the accommodating member 531.

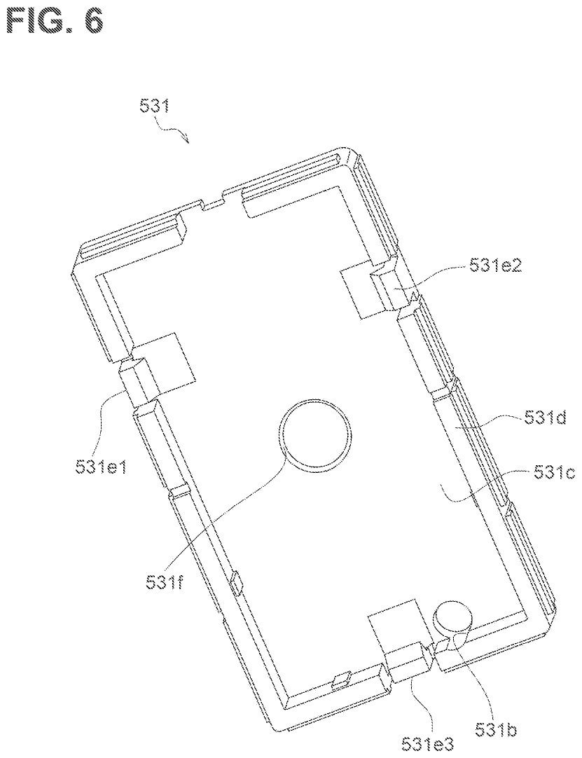

As illustrated in FIG. 6, the accommodating member 531 has a recess 531c that is open downward. Since the accommodating member 531 has the recess 531c, its ceiling portion (or bottom portion of the recess 531c) is small in thickness. This may prevent the occurrence of sink marks that are shallow depressions or dimples on the surface if the accommodating member 531 is a relatively large plate-shaped member.

As illustrated in FIG. 6, the accommodating member 531 has three hook portions 531e1 to 531e3 in an annular side wall 531d defining the recess 531c. The hook portions 531e1 and 531e2 are located on long side portions of the annular side wall 531d. The hook portions 531e3 is located on a short side portion of the annular side wall 531d. As illustrated in FIG. 4, the hook portion 531e3 has a lower end portion protruding inward so as to be engageable with a stopper member 540 described later. The other hook portions 531e1 and 531e2 can be also engageable with the stopper member 540, similarly to the hook portion 531e3. As illustrated in FIG. 6, the accommodating member 531 has a circular recess 531f in a center of its ceiling portion that is a portion corresponding to the bottom portion of the recess 531c.

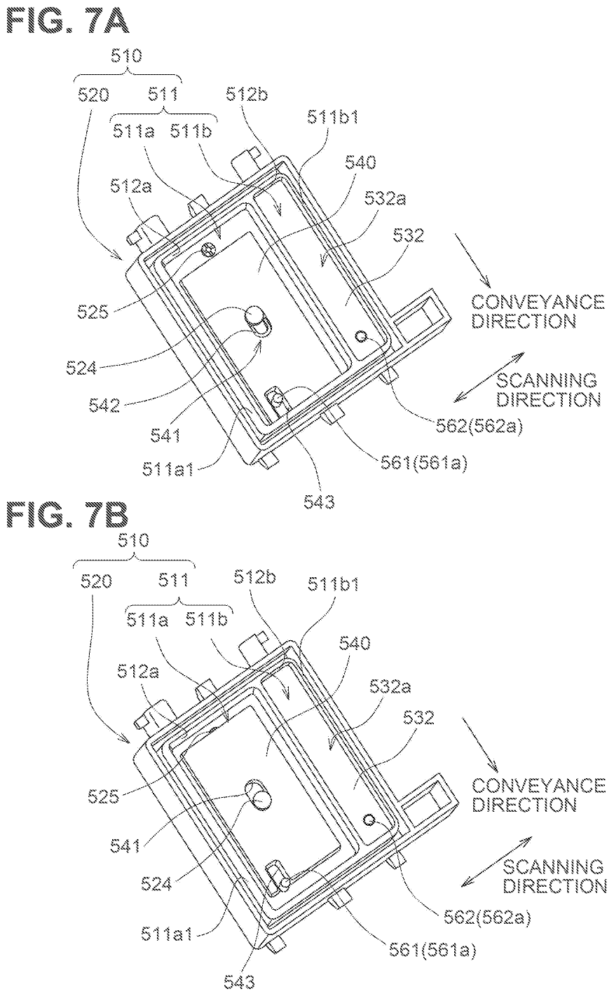

As illustrated in FIGS. 5 and 7, the accommodating member 532 is disposed in the recess 512b of the second cap portion 511b, has a substantially rectangular parallelepiped shape, and is longer in the conveyance direction than in the scanning direction. The accommodating member 532 has an outer peripheral side surface that is in contact with an inner peripheral side surface of the annular side wall 511b1 defining the recess 512b. The accommodating member 532 is configured to face and be spaced from the nozzle surface 11a when the head 1 is at the maintenance position and the upper end portion of the cap 511 and the nozzle surface 11a are in intimate contact with each other. Specifically, the accommodating member 532 is configured to face all of the nozzles 11n for ejecting black ink. That is, the upper surface of the accommodating member 532 forms a landing surface 532a on which the black ink droplets ejected from the nozzles 11n land.

As illustrated in FIG. 5, the landing surface 532a is a horizontal surface, is parallel to the nozzle surface 11a of the head 1 in the maintenance position, and is flat. As illustrated in FIGS. 3 and 5, the accommodating member 532 has a circular hole 532b. The hole 532b is located in a downstream portion of the accommodating member 532 in the conveyance direction and to the left with respect to the center in the scanning direction in FIG. 3. The hole 532b receives an electrode pin 562. The electrode pin 562 has an upper end surface 562a1. The upper end surface 562a1 is exposed from the hole 532b so as to be flush with the upper surface of the accommodating member 532, and forms the landing surface 532a together with the upper surface of the accommodating member 532. The hole 532b is the same size as the hole 531b.

The upper surface of the accommodating member 531 constituting the landing surface 531a and the upper surface of the accommodating member 532 constituting the landing surface 532a are textured entirely. The arithmetic average roughness (Ra) of the surface texturing on the landing surfaces 531a and 532a is 32 in this embodiment, but may be set to an appropriate value other than Ra32 if the textured surfaces do not have asperities that affect the ejection detection accuracy.

The holder 520 is non-conductive. In this embodiment, the holder 520 is made of a non-conductive synthetic resin. As illustrated in FIGS. 4 and 5, the holder 520 includes a horizontal bottom portion 521 and an annular side wall 522 protruding upward from the outer periphery of the bottom portion 521. In the holder 520, a recess 523 that is open upward is defined by the bottom portion 521 and the annular side wall 522. The cap 511 is disposed in the recess 523, and the cap 511 is supported from below by the bottom portion 521.

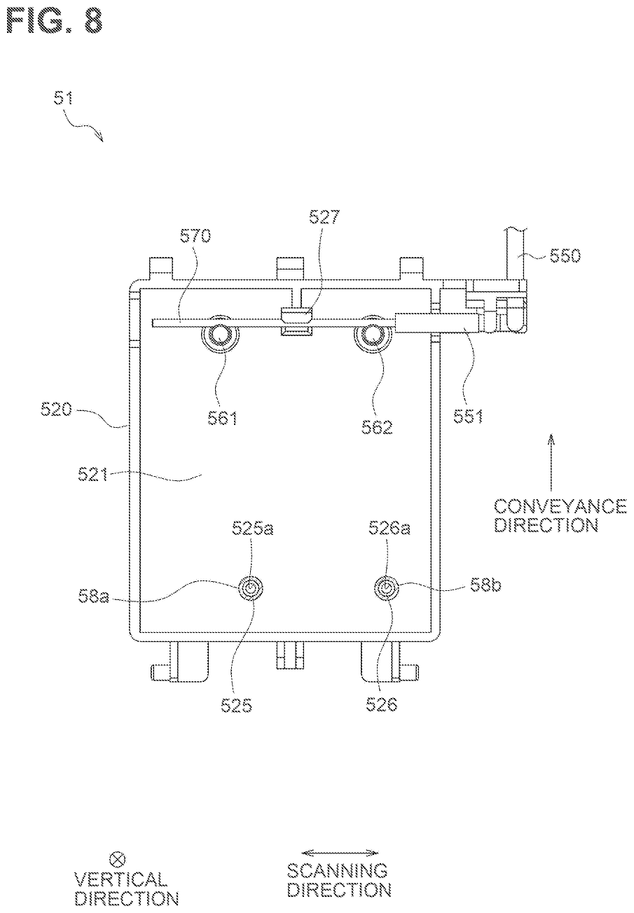

As illustrated in FIGS. 4 and 8, the holder 520 has a protrusion 524 and two tube portions 525 and 526. As illustrated in FIGS. 7A and 7B, the protrusion 524 protrudes upward from a portion of the bottom portion 521 facing the central portion of the first cap portion 511a, and extends through the bottom portion 511a2 of the first cap portion 511a. The protrusion 524 has a substantially cylindrical shape. As illustrated in FIG. 4, an upper end portion of the protrusion 524 protruding in the recess 512a has an annular groove 524a extending along an outer peripheral side surface thereof. The upper end of the protrusion 524 is disposed in the recess 531f of the accommodating member 531.

As illustrated in FIGS. 4, 5 and 7, the stopper member 540 is disposed in the recess 512a of the first cap portion 511a. The stopper member 540 is non-conductive like the holder 520. In this embodiment, the stopper member 540 is made of a non-conductive synthetic resin.

As illustrated in FIGS. 4 and 5, the stopper member 540 is disposed between the accommodating member 531 and the bottom portion 511a2 of the first cap portion 511a. As illustrated in FIG. 7, the stopper member 540 is a plate-shaped member having a rectangular planar shape, and has a through hole 541 in a central portion thereof. The through hole 541 is elongated in the conveyance direction. The through hole 541A is defined by an inner peripheral surface that has a protrusion 542 that is engageable in the groove 524a. The protrusion 542 has a U-shape along a downstream half portion, in the conveying direction, of the inner peripheral surface defining the through hole 541. The stopper member 540 has a cutout portion 543 in its downstream end portion in the conveying direction. The cutout portion 543 is located in a left portion of the stopper member 540 in the scanning direction.

As illustrated in FIG. 7A, the stopper member 540 is shorter than the recess 512a in the conveyance direction. The stopper member 540 is moved from the first position to the second position in the recess 512a, whereby the protrusion 542 is fitted in the groove 524a of the protrusion 524 and retains the protrusion 524. The first position refers to a position of the stopper member 540 illustrated in FIG. 7A where the protrusion 524 is located in an upstream portion of the through hole 541 of the stopper member 540 in the conveyance direction. The second position refers to a position of the stopper member 540 slid upstream from the first position in the conveyance direction with respect to the recess 512a. This prevents the protrusion 524 from coming off from the cap 511, and thus the cap 511 is fixed to the holder 520.

As illustrated in FIG. 7B, the stopper member 540 at the second position has a planar size that allows positioning of the annular side wall 531d of the accommodating member 531 in a space between the stopper member 540 and the annular side wall 511a1. In other words, the stopper member 540 has a size to be accommodated in the recess 531c of the accommodating member 531. The stopper member 540 has three cutout portions 544 on its outer peripheral side surface. In FIG. 4, one of the three cutout portions 544 is shown. These three cutout portions 544 are formed at positions corresponding to the three hook portions 531e1 to 531e3 of the accommodating member 531. As illustrated in FIG. 3, the accommodating member 531 covering the stopper member 540 is disposed in the recess 512a, where the three hook portions 531e1 to 531e3 are engaged with the three cutout portions 544, and the accommodating member 531 is fixed to the stopper member 540.

As illustrated in FIG. 8, the tube portion 525 is disposed in an area of the bottom portion 521 that is supposed to face the first cap portion 511a. Specifically, the tube portion 525 is disposed in a central portion of the area in the scanning direction and an upstream portion of the area in the conveyance direction. As illustrated in FIG. 4, the tube portion 525 extends through the bottom portion 521 and the bottom portion 511a2 of the first cap portion 511a, and has a discharge hole 525a extending in the vertical direction. The discharge hole 525a is a hole for discharging ink in the first cap portion 511a, and communicates with a suction pump 56 via a tube 58a. The discharge hole 525a is covered by the stopper member 540 with a clearance therebetween.

As illustrated in FIG. 8, the tube portion 526 is disposed in an area of the bottom portion 521 that is supposed to face the second cap portion 511b. Specifically, the tube portion 526 is disposed in a central portion of the area in the scanning direction and an upstream portion of the area in the conveyance direction. The tube portion 526 extends through the bottom portion 521 and the bottom portion 511b2 of the second cap portion 511b, and has a discharge hole 526a extending in the vertical direction. The discharge hole 526a is a hole for discharging ink in the second cap portion 511b, and communicates with the suction pump 56 via a tube 58b. The discharge hole 526a is covered by the accommodating member 532 with a clearance therebetween.

The two electrode pins 561 and 562 has electrical conductivity. The two electrode pins 561 and 562 in the this embodiment are made of stainless steel, but may be made of other conductive materials. As illustrated in FIG. 5, the electrode pin 561 extends through the bottom portion 521 of the holder 520, the bottom portion 511a2 of the first cap portion 511a, the stopper member 540, and the accommodating member 531 in the vertical direction. The electrode pin 562 extends through the bottom portion 521 of the holder 520, the bottom portion 511b2 of the second cap portion 511b, and the accommodating member 532 in the vertical direction.

As illustrated in FIG. 5, the electrode pins 561 and 562 have the same shape and size. The electrode pins 561 and 562 have cylindrical pin bodies 561a and 562a extending in the vertical direction and protruding portions 561b and 562b protruding from the side surfaces of the pin bodies 561a and 562a. The pin bodies 561a and 562a have diameters slightly smaller than the holes 531b and 532b, and minute gaps 571 and 572 are formed between the pin bodies 561a and 562a and the holes 531b and 532b. Since ink ejected from the nozzles 11n is in the gaps 571 and 572, the electrode pin 561 is electrically connected to the accommodating member 531, and the electrode pin 562 is electrically connected to the accommodating member 532.

The protruding portions 561b and 562b each have an annular shape over the entire circumferences of the pin bodies 561a and 562a at the centers of the pin bodies 561a and 562a in the vertical direction. These electrode pins 561 and 562 are integrally molded with the holder 520.

Here, a method of manufacturing the support member 510 will be described. First, the two electrode pins 561 and 562 are positioned in a mold (not shown) for molding the holder 520. At this time, the electrode pin 561 is positioned so as to penetrate the bottom portion 521 of the holder 520 to be molded in the vertical direction at a position included in a downstream portion of the bottom portion 521 in the conveyance direction and a portion (on the left side in FIG. 3) of the area of the bottom portion 521 that is supposed to face the first cap portion 511a in the scanning direction. The electrode pin 562 is positioned so as to penetrate the bottom portion 521 of the holder 520 to be molded in the vertical direction at a position included in a downstream portion of the bottom portion 521 in the conveyance direction and a portion (on the left side in FIG. 3) of the area of the area of the bottom portion 521 that is supposed to face the second cap portion 511b in the scanning direction. At this time, the two electrode pins 561 and 562 are positioned in the mold such that the protruding portions 561b and 562b are positioned in the bottom portion 521 of the holder 520 to be molded. Thereafter, a non-conductive synthetic resin material is poured into the mold. Once demolding is completed after the material is cured, the holder 520 and the two electrode pins 561 and 562 are manufactured in one piece. Thereafter, the cap 511 is attached to the holder 520, and the stopper member 540 is engaged with the holder 520, thereby manufacturing the support member 510.

Since the protruding portions 561b and 562b of the electrode pins 561 and 562 are located in the bottom portion 521 of the holder 520 as described above, the upper and lower surfaces of the protruding portions 561b and 562b are engaged with portions constituting the bottom portion 521 as illustrated in FIG. 5. This retains the protruding portions 561b and 562b of the electrode pins 561 and 562 immovably in the vertical direction in the holder 520. The bottom portion 521 of the holder 520 is in contact with the side surfaces of the electrode pins 561 and 562 entirely.

As illustrated in FIGS. 5 and 8, a connection member 570 is disposed below the bottom portion 521 of the holder 520. The connection member 570 is a cylindrical bar-shaped member extending in the scanning direction. The connection member 570 has electrical conductivity. The connection member 570 in the this embodiment is made of stainless steel, but may be made of a different conductive material. As a modification, the connection member 570 may be made of a synthetic resin having electrical conductivity. This enables the weight of the connection member 570 to be reduced compared with the connection member 570 made of metal.

As illustrated in FIG. 8, the connection member 570 has one end crimped to a crimp terminal 551 attached to one end of the high-voltage harness 550. In other words, the connection member 570 is connected to the high-voltage harness 550 via the crimp terminal 551. The connection member 570 is disposed in contact with the downstream side portions of the two electrode pins 561 and 562 in the conveyance direction, and electrically connects the two electrode pins 561 and 562 and the high-voltage harness 550. The holder 520 includes a holding portion 527 that protrudes downward from the bottom portion 521 and holds a central portion of the connection member 570 in the scanning direction. The holding portion 527 is located further downstream than the two electrode pins 561 and 562 in the conveyance direction to press the connection member 570 toward the two electrode pins 561 and 562. This enables the connection member 570 to be reliably brought into contact with the two electrode pins 561 and 562.

As illustrated in FIG. 1, a substrate unit 580 is disposed downstream of the cap 511 in the conveyance direction. As illustrated in FIG. 4, the substrate unit 580 includes a substrate 581 and a case 582 that accommodates the substrate 581. A high voltage application circuit 583 and a voltage detection circuit 584 are packaged on the substrate 581. A female connector 581a electrically connected to the high voltage application circuit 583 and the voltage detection circuit 584 is mounted on the substrate 581.

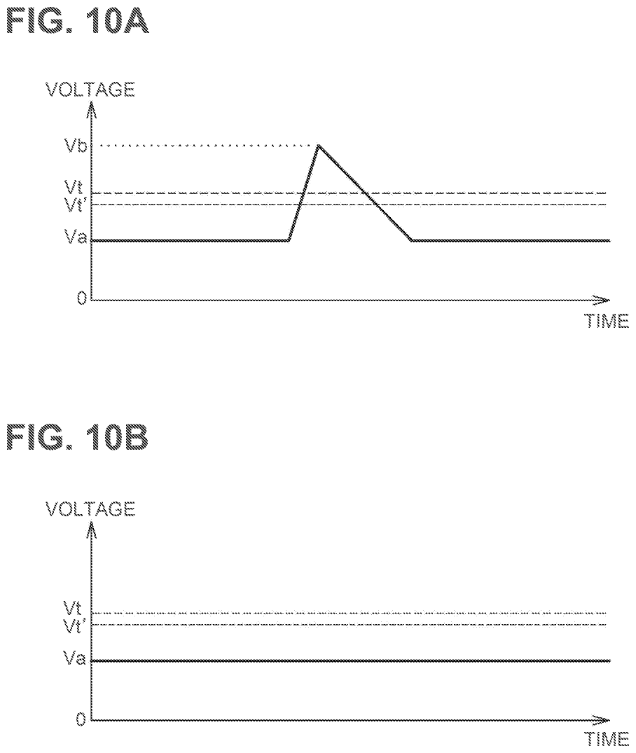

As illustrated in FIG. 5, a male connector 552 that is attachable to and detachable from the female connector 581a is attached to the other end of the high-voltage harness 550. As illustrated in FIG. 4, the high voltage harness 550 is electrically connected to the high voltage application circuit 583 and the voltage detection circuit 584 of the substrate 581 via the male connector 552 and the female connector 581a. The high voltage application circuit 583 and the voltage detection circuit 584 are thus electrically connected to the two accommodating members 531 and 532 via the high-voltage harness 550 and the electrode pins 561 and 562. The high-voltage harness 550 transmits voltage from the high voltage application circuit 583 to the accommodating members 531 and 532, and transmits a signal indicating the voltage of the accommodating members 531 and 532 to the voltage detection circuit 584. The high voltage application circuit 583 applies a high voltage Va (see FIG. 10) to the two accommodating members 531 and 532 under the control of the controller 9. The voltage Va is about 500 V. The channel unit 11 of the head 1 is conductive (for example, made of a metal material) and is maintained at the ground potential. This generates a potential difference between the head 1 and the two accommodating members 531 and 532. The voltage detection circuit 584 outputs a signal indicating a voltage of the two accommodating members 531 and 532 (that is, a potential difference between the head 1 and the two accommodating members 531 and 532) to the controller 9. The high-voltage harness 550, and the high voltage application circuit 583 and the voltage detection circuit 584 of the substrate 581 may be electrically connected by a connection other than a connector, or the male and female connectors may be switched.

The substrate 581 and the controller 9 are connected by a flexible flat cable (FFC). That is, the high voltage application circuit 583 and the voltage detection circuit 584 are connected to the controller 9 by the FFC. The FFC has a length longer than the shortest wiring route between the substrate 581 and the controller 9 in the printer 100. This eliminates the need to remove the FFC from the substrate 581 when the substrate unit 580 is temporarily detached from the printer 100. This prevents problems including a data loss that can occur when the FFC is removed. Such problems can be avoided even when the waste liquid tank 57 described later is temporarily removed from the printer 100 after the substrate unit 580 is removed from the printer 100.

As illustrated in FIG. 4, the substrate 581 is disposed above an upper end of the waste liquid tank 57 in the vertical direction. That is, the substrate 581 is disposed above an inlet 57b (described later) of the waste liquid tank 57 to which ink is discharged. The substrate 581 is disposed at a position overlapping the waste liquid tank 57 in the vertical direction. The substrate 581 is disposed above one end of the high-voltage harness 550 connected to the connection member 570. As illustrated in FIG. 4, the high-voltage harness 550 is inclined downward from the substrate 581 toward the holder 520 (or the connection member 570).

As illustrated in FIG. 4, the discharge mechanism 55 includes a suction pump 56 and tubes 58a, 58b, and 59, and is a mechanism that discharges ink discharged into the cap 511 to the waste liquid tank 57. In other words, the discharge mechanism 55 connects the cap 511 and the waste liquid tank 57. A waste liquid foam (not shown) is disposed in a lower portion of the printer. The tube 58a has one end connected to a lower portion of the tube portion 525, and the other end connected to the suction pump 56. The tube 58a has one end connected to a lower portion of the tube portion 526, and the other end connected to the suction pump 56. The tube 59 has one end connected to the suction pump 56, and the other end connected to the waste liquid tank 57. The suction pump 56 is driven under the control of the controller 9, whereby ink in the cap 511 is discharged to the waste liquid tank 57.

As illustrated in FIG. 4, the waste liquid tank 57 has a tank main body 57a having an internal space and a foam 57c disposed in the internal space. The tank main body 57a has an upper surface having the inlet 57b to which the other end of the tube 59 is connected. Ink sucked by the suction pump 56 is discharged from the inlet 57b into the tank main body 57a, and penetrates into the foam 57c. The waste liquid tank 57 is connected at a lower portion thereof to the waste liquid foam, and the ink discharged to the waste liquid tank 57 is subsequently transferred to the waste liquid foam. The tube 59 has a length longer than the high-voltage harness 550.

As illustrated in FIG. 9, the controller 9 includes a central processing unit (CPU) 91, a read only memory (ROM) 92, a random access memory (RAM) 93, and an application specific integrated circuit (ASIC) 94 including various control circuits. The controller 9 is connected to an external device such as a PC so as to enable data communication.

The ROM 92 stores programs and data to be read by the CPU 91 to control various operations. The RAM 93 temporarily stores data to be used by the CPU 91 to execute the program. On receiving a recording command from an external device, the CPU 91 issues a command to the ASIC 94 in accordance with a program or data stored in the RAM 93 or ROM 92.

The ASIC 94 is connected to a driver IC 15, the carriage motor 25, the conveyance motor 45, a cap lifting motor 54, the suction pump 56, the voltage application circuit 583, and the voltage detection circuit 584.

In recording, the ASIC 94 drives, in accordance with an instruction from the CPU 91, the driver IC 15, the carriage motor 25, and the conveyance motor 45 to alternately perform a “conveyance operation” to convey a sheet P in the conveyance direction and an “ejection operation” to cause ink droplets to be ejected from the nozzles 11n while moving the carriage 2 in the scanning direction. That is, during recording, the sheet P is intermittently conveyed. The above-described operations are repeated, and thus an image is recorded on the sheet P with ink dots.

In maintenance, the ASIC 94 drives, in accordance with a command from the CPU 91, the carriage motor 25 to move the head 1 at the maintenance position and drives the cap lifting motor 54 to move the cap device 51 upward. This allows an upper end of the cap 511 to come in contact with the nozzle surface 11a, thus covering the nozzle surface 11a with the cap 511. The maintenance unit 5 has a lifting mechanism (not shown) that lifts and lowers the cap device 51 in the vertical direction. When the cap lifting motor 54 is driven, the cap 511 is movable between a contact position where the upper end of the cap 511 is in contact with the nozzle surface 11a and a separation position where the cap 511 is spaced from the nozzle surface 11a. The horizontal landing surfaces 531a and 532a formed by the accommodating members 531 and 532 and the upper end surfaces 561a1 and 562a1 of the two electrode pins 561 and 562 are spaced downward by a predetermined distance from the nozzle surface 11a at the contact position.

When the suction pump 56 is driven with the nozzle surface 11a covered with the cap 511, the inside of the cap 511 becomes a negative pressure, ink is forcibly discharged from all the nozzle 11n, and the ink is received in the cap 511 (this is called suction purge). The ink is received on the landing surfaces 531a and 532a of the accommodating members 531 and 532, and received in the gaps 571 and 572.

The surface of the ink received in each of the gaps 571 and 572 is slightly below the landing surfaces 531a and 532a due to capillary action in the gaps 571 and 572, but there is no great height difference that affects the accuracy for determining ejection states of the nozzles described later.

The ink received in the cap 511 reaches the discharge holes 525a and 526a through grooves (not shown) formed in the side surfaces and the lower surfaces of the accommodating members 531 and 532, and is stored in the waste liquid tank 57 through the tubes 58a, 58b, and 59 and the suction pump 56. However, the ink received in the gaps 571 and 572 remains held in the gaps 571 and 572.

When determining an ejection state of each nozzle or detecting a clogging nozzle, the ASIC 94 follows an instruction from the CPU 91, drives the carriage motor 25 to place the head 1 at the maintenance position, and drives the driver IC 15 to cause the head 1 to eject ink droplets from the nozzles 11n toward the accommodating members 531 and 532 in the cap 511.

In this embodiment, the high voltage application circuit 583 applies a positive voltage Va to the accommodating members 531 and 532 functioning as electrodes used for ejection state determination. Ink is positively charged. While an ink droplet is ejected from a nozzle 11n and lands on the landing surface 531a or 532a, the voltage of the accommodating member 531 or 532 increases and reaches a voltage Vb higher than the voltage Va (see FIG. 10A). After the ink droplet lands on the landing surface 531a or 532a, the voltage of the accommodating member 531 or 532 gradually decreases and returns to the voltage Va. If an ink droplet is not ejected from a nozzle 11n, the voltage of the accommodating member 531 or 532 hardly changes from the voltage Va (see FIG. 10B).

Ink held in each of the gaps 571 and 572 also functions as an electrode used for ejection state determination. That is, the high voltage application circuit 583 applies the positive voltage Va to the ink held in the gaps 571 and 572 as well as the accommodating members 531 and 532. When ink is ejected toward the gaps 571 and 572 during ejection state determination, the voltage of the ink changes similarly to that of the accommodating member 531 or 532 described above.

The ASIC 94 determines a clogging nozzle based on a signal output from the voltage detection circuit 584 (i.e., a signal indicating voltage of the accommodating member 531 or 532). Specifically, when the voltage of the accommodating member 531 exceeds a threshold value Vt or the voltage of the accommodating member 532 exceeds a threshold value Vt′, the ASIC 94 determines that a nozzle 11n is not clogged (that is, there is no abnormality in the ejection state of the nozzle 11n). The determination is performed for each nozzle 11n.

The ASIC 94 performs appropriate processing based on the determination result. For example, in a case where the nozzles 11n include one or more nozzles 11n determined as clogged (that is, determined that the ejection state is abnormal), a suction purge (which is a process of driving the suction pump 56 and forcibly discharging ink from the nozzles 11n) is executed. In a case where the nozzles 11n do not include a nozzle 11n determined as clogged (that is, determined that the ejection state of the nozzle 11n is abnormal), the suction purge is not performed, and the recording process (of alternately performing the “conveyance operation” and the “ejection operation” described above) based on the recording command is performed. Alternatively, as to a nozzle 11n determined as clogged, that is, determined that the ejection state is abnormal, flushing, which is a process of ejecting ink from the nozzle 11n by driving the driver IC 15, may be performed.

The ROM 92 stores threshold values Vt and Vt′, one of which is assigned to each nozzle 11n. The threshold values Vt and Vt′ are higher than the voltage Va and lower than the voltage Vb.

The printer 100 in this embodiment corresponds to the “liquid ejecting apparatus” of the disclosure. The head 1 in this embodiment corresponds to a “liquid ejection head” of the disclosure. Each of the accommodating members 531 and 532 in the this embodiment corresponds to a “conductive member” of the disclosure. The voltage detection circuit 584 in the this embodiment corresponds to a “signal output circuit” of the disclosure. The CPU 91 and the ASIC 94 in this embodiment correspond to a “controller” of the disclosure. The vertical direction in the this embodiment corresponds to an “up-down direction” of the disclosure.

As described above, according to the printer 100 of this embodiment, the substrate 581 is disposed above the inlet 57b of the waste liquid tank 57. For example, when the tube 59 is attached to or detached from the inlet 57b, ink dripping from the inlet 57b of the waste liquid tank 57 is less likely to adhere to the substrate 581. This prevents short circuiting in the voltage detection circuit 584 and the high voltage application circuit 583 of the substrate 581.

The substrate 581 is disposed above the upper end of the waste liquid tank 57. This prevents the substrate 581 from receiving ink drips.

The substrate 581 overlaps the waste liquid tank 57 in the vertical direction (up-down direction). This prevents an increase in physical size of the printer 100 in a direction (horizontal direction) orthogonal to the vertical direction.

One end of the high-voltage harness 550 connected to the connection member 570 is disposed below the substrate 581. This reduces the likelihood that the substrate 581 receives ink droplets which may drip from the high-voltage harness 550 if ink mist floating in the printer 100 gathers on and moves along the high-voltage harness 550.

The tube 59 has a length longer than the high-voltage harness 550. Due to its relatively long length, the tube 59 can be attached to and detached from the waste liquid tank 57 after the waste liquid tank 57 is temporarily detached from the printer main body. This facilitates removability of the waste liquid tank 57 from the printer main body. This also eliminates the need to lengthen the high-voltage harness 550 excessively. Thus, the influence of noise that can be generated by lengthening the high-voltage harness 550 may be reduced, and the accuracy of the ejection state determination can be maintained.

The two electrode pins 561, 562 and the high voltage harness 550 are connected by the connection member 570. The use of the connection member 570 eliminates the preparation of as many high-voltage harnesses 550 as the electrode pins 561 and 562. This eliminates the need to increase the physical size of the printer 100 and prevents an increase in the manufacturing cost of the printer 100 as compared with a case where a plurality of high-voltage harnesses are provided.

The high voltage harness 550 is detachably connected to the high voltage application circuit 583 and the voltage detection circuit 584 of the substrate 581 via the male connector 552. This facilitates removal of the high-voltage harness 550 from the substrate 581.

The high-voltage harness 550 is held by the holder 520, but is not fixed except at both ends thereof. This facilitates removal of the substrate unit 580 (that is, the substrate 581).

While the disclosure has been described in detail with reference to the specific embodiment thereof, this is merely an example, and various changes, arrangements and modifications may be applied therein without departing from the spirit and scope of the disclosure. In the above-described embodiment, the substrate 581 is disposed above the waste liquid tank 57, but it is only required that the substrate 581 is disposed above the inlet 57b of the waste liquid tank 57. At this time, the inlet 57b may be disposed on a side surface or a lower portion of the waste liquid tank 57. That is, the substrate 581 may partially overlap with the waste liquid tank 57 in the vertical direction. The substrate 581 may not overlap with the waste liquid tank 57 in the vertical direction.

In the above-described embodiment, the high-voltage harness 550 is used to connect the high voltage application circuit 583 and the voltage detection circuit 584 to the connection member 570. The voltage detection circuit 584 and the connection member 570 may be connected via a harness which is not for high-voltage use. In this case, another high-voltage harness may be used to connect the high voltage application circuit 583 and the accommodating members 531 and 532.

The tube 59 may have a length shorter than or equal to the high-voltage harness 550.

The connection member 570 may be a rectangular column or elliptical rod, or may be any shaped member. In short, it is required that the connection member 570 is configured to contact the electrode pins 561 and 562 to connect the electrode pins 561 and 562 to the voltage detection circuit 584.

The high-voltage harness 550 is detachably connected to the substrate 581 via the connector 552, but may be directly fixed to the substrate 581 in a non-detachable manner.

Further, in the above-described embodiment, the high voltage application circuit 583 applies the positive voltage Va to the accommodating members 531 and 532, but may apply a negative voltage Va to the accommodating members 531 and 532 to determine the ejection states of the nozzles 11n.

The disclosure has been applied to, but is not limited to, a printer having a head that ejects ink from nozzles. The disclosure can also be applied to a liquid ejection apparatus having a liquid ejection head that ejects a liquid other than ink.

What is claimed is:

1. A liquid ejection apparatus comprising;
a liquid ejection head having a nozzle surface with a plurality of nozzles, the liquid ejection head being configured to eject liquid from the nozzles;
a conductive member configured to face the nozzle surface;
a cap having a recess in which the conductive member is accommodated, the cap being configured to receive liquid ejected from the nozzles;
a substrate including a signal output circuit configured to output a signal in response to ejection of liquid from a nozzle of the nozzles to the conductive member, the signal indicating a potential difference between the liquid ejection head and the conductive member;
a controller configured to determine an ejection state of the nozzle based on the signal output from the signal output circuit;
a waste liquid tank having an inlet; and
a discharge mechanism configured to discharge liquid from the cap through the inlet into the waste liquid ink,
wherein the substrate is disposed above the inlet of the waste liquid tank.

2. The liquid ejection apparatus according to claim 1, wherein the substrate is disposed above an upper end of the waste liquid tank.

3. The liquid ejection apparatus according to claim 1, wherein the substrate overlaps the waste liquid tank in an up-down direction.

4. The liquid ejection apparatus according to claim 1, further comprising:
an electrode pin having conductivity and electrically connected to the conductive member; and
a harness having a first end and a second end opposite to the first end, the first end being electrically connected to the signal output circuit, the second end being electrically connected to the electrode pin,
wherein the second end of the harness is disposed below the substrate.

5. The liquid ejection apparatus according to claim 4, wherein the discharge mechanism includes a tube to transfer liquid from the cap to the waste liquid tank, the tube having a length longer than the harness.

6. The liquid ejection apparatus according to claim 4,
wherein the conductive member is one of a plurality of conductive members,
wherein the electrode pin is one of a plurality of electrode pins, each pin corresponding to a conductive member of the conductive members,
wherein the liquid ejection apparatus further comprises a connection member having conductivity, the connection member electrically connecting the harness and the electrode pins.

7. The liquid ejection apparatus according to claim 4,
wherein the substrate includes a high-voltage application circuit configured to apply a high-voltage to the conductive member,
wherein the harness is a high-voltage harness having a connector at the first end, and
wherein the high-voltage harness is detachably connected via the connector to the signal output circuit and the high-voltage application circuit of the substrate.

8. A liquid ejection apparatus comprising;
a liquid ejection head having a nozzle surface with a plurality of nozzles;
a conductive member configured to face the nozzle surface;
a cap having a recess in which the conductive member is accommodated;
a substrate including a circuit configured to output a signal in response to ejection of liquid from a nozzle of the nozzles to the conductive member;
a waste liquid tank having an inlet; and
a discharge mechanism connecting the cap and the inlet of the waste liquid tank,
wherein the substrate is disposed above the inlet of the waste liquid tank.
